(19) United States
(12) Patent Application Publication
(10) Pub. No.: US 2008/0222911 A1
(43) Pub. Date: Sep. 18, 2008

(54) SYSTEM AND METHOD TO REMOVE MOISTURE FROM WOOD

(76) Inventors: Lundberg David, Muskegon, MI (US); Bartnick John, Wyoming, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/686,129

(22) Filed: Mar. 14, 2007

(51) Int. Cl. F26B 7/00

(52) U.S. Cl. 34/418

(57) ABSTRACT

A system and process is provided to deplete or remove moisture from wood coring in boats. The system and process does not require the destruction, removal, or reconstruction of the wood coring. The present invention comprises piercing of the wood coring to create bores therethrough. Next, blowing ultra dry air through the bores, this removes moisture from the coring. And finally sealing the holes with a sealant.

### BACKGROUND OF THE INVENTION

This invention relates to a system and method of drying wood structures, particularly those found in boats.

Boats may be comprised of wood coring in certain areas. The coring may be stringers and bulkheads. Coring provides hull strength. Wood coring can weigh less than fiberglass coring. Wood coring is usually coated with fiberglass, to form a fiberglass outer skin. However moisture can still enter the wood coring. When moisture enters the wood coring it can weaken the structural integrity of the wood coring. In some cases the wood coring becomes saturated, partially saturated, or moldy. The boat may then become too weak to operate safely in the water; or it may be a source of toxic mold, rot or cause of other respiratory problems. Further, the boat may be un-insurable when moisture enters the coring. Thus the coring may have to be cut, or removed and then rebuilt.

U.S. Pat. No. 6,886,271 (“the '271 patent”) discloses a system to remove water and moisture from hard wood flooring. This patent does not disclose hole creation or the drilling of holes to expose wood, and to remove moisture therefrom.

As can be seen, there is a need for a system and method that removes moisture from wood coring. There is also a need for a system and method that does not require the removal and reconstruction of coring. There is also a need for a system and method to remove moisture from coring at a reduced cost, and with less down time of the boat, which prolongs the life of the boat. There is also a need for a system and method to apply a sealant, epoxy, or protectant that penetrates the wood; and to apply a sealant, epoxy, or protectant to fill holes in wood coring.

### SUMMARY OF THE INVENTION

One aspect of the present invention is a method of removing moisture from wood coring of a boat, comprising the steps of: piercing the wood coring to create an exposed portion; pumping fluid into the exposed portion; penetrating the exposed portion with a sealant; and filling the exposed portion with a sealant.

Another aspect of the present invention is a method to remove moisture from wood coring of a boat, comprising: creating holes into the wood coring; pumping dry air into the holes; and hermetically sealing the holes.

These and other features, aspects and advantages of the present invention will become better understood with reference to the following drawings, description and claims.

### BRIEF DESCRIPTION OF THE DRAWINGS

FIG. 1 illustrates a schematic of an embodiment of a moisture removal system of the present invention; and

FIG. 2 illustrates a schematic of an exemplary method of use of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be used for removing moisture from wood. Moisture may include liquid and water. The present invention is of particular importance for use to remove moisture from the coring and other wood components of boats and even other non-boat structures and items.

The present invention differs from the prior art by, among other things, the use of a method that removes moisture but does not require destruction and reconstruction of the coring.

The present invention allows the structural integrity of the structure or coring to remain, which (1) reduces the cost involved in removing the coring and reconstructing new coring; (2) reduces the time in which the boat is unavailable for use because of the time involved to remove and reconstruct coring.

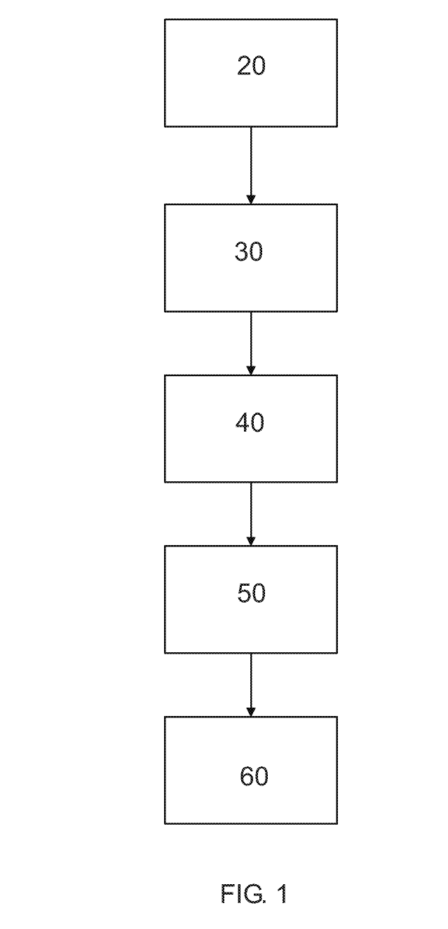

FIG. 1 is a general schematic that illustrates an embodiment of a moisture removal system 10 of the present invention, including steps that may include:

1. piercing 20 a an outer skin, such as fiberglass (this is not necessary if the wood has no outer skin);

2. forming 30 bores or holes 200 in wood coring to form an exposed portion (forming may be performed by drilling);

3. pumping 40 dry air into the bores or holes 200 (an alternative embodiment may include “sucking” or “pulling” the air towards a vacuum device);

4. penetrating 50 an exposed portion 80; with a sealant 100; and

5. filling 60 the exposed portion 80 with a sealant 100.

In one exemplary embodiment of the present invention, the piercing step 20 includes the forming 30 of bores or holes 200 that may be spaced apart by a distance of about 8 inches. In one exemplary embodiment, the forming 30 of bores or holes 200 can be created by drilling the bores or holes 200. In one exemplary embodiment, the spacing 70 of the bores or holes 200 may be greater than 8 inches. In one exemplary embodiment, the spacing 70 of the bores or holes 200 may be less than 8 inches. In one exemplary embodiment, the spacing 70 of the bores or holes 200 may vary. The forming 30 of bores or holes 200 creates an exposed portion 80 of the coring.

The pumping step 40 may be performed by pumping in ultra dry air from an inlet end 300 of the bore 200, so that the ultra dry air is displaced adjacent to the exposed portion 80, to remove moisture from the coring. In one exemplary embodiment the ultra dry air may be pumped in by using a first pumping step 42, and a second pumping step 44. The first pumping step 42 may include the use of an air dryer. In one exemplary embodiment, the air dryer may be a Dri-Force desiccant. In one exemplary embodiment the second pumping step 44 may include the use of a mid pressure, high volume pump.

The first pumping step 42 may be used to dry the air in and around the exposed portion 80. The second pumping step 44 may be used to pump air into the exposed portion 80. In one exemplary embodiment, the first pumping step 42 may be used to dry the air to create and ultra dry air 90. The second pumping step 44 may include capturing 110 the ultra dry air 90, and then displacing the ultra dry air 90 into the exposed portion 80.

In one exemplary embodiment, the penetrating step 50 may include penetrating the exposed portion 80 with a first sealant 100 or epoxy. The filling step 60 may include the filling 60 of the exposed portion 80 with a second sealant 100′ or epoxy. In a further embodiment only one of the penetrating 50 or filling 60 step may be used, in other words both may not always be necessary.

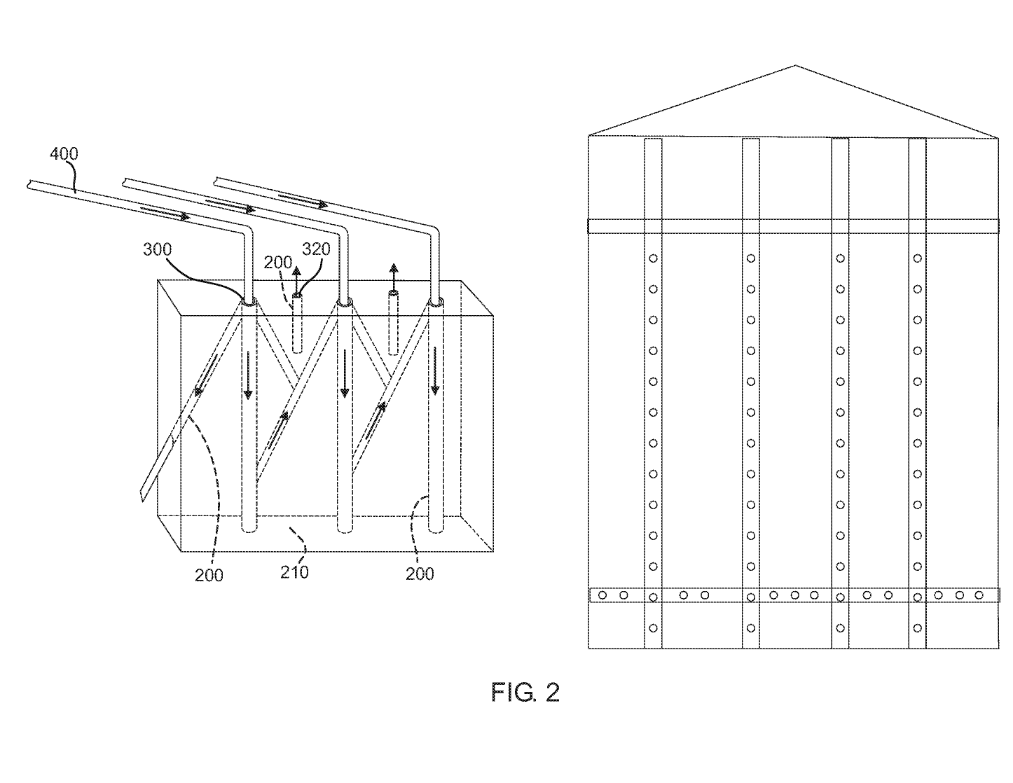

FIG. 2 illustrates one exemplary method and type of apparatus employable of using the system, including the forming 30 of a plurality of bores 200 within a stringer 210. The bores 200 are capable of having an inlet end 300, and an outlet end 320. The inlet end 300 may receive air from an external source 400, such as an air pump. The outlet end 320 enables an escape or exit route for the air pumped in through the inlet end 300. As the air is displaced throughout the bores 200 adjacent the exposed portion 80, and out of the outlet end 320; the moisture is removed. The bores 200 may be created by a drill. Another exemplary embodiment may include, rather than “pushing” air through the system with the external source, but to “pull” or “suck” air using the external source 400 as a vacuum.

After moisture is removed, either partially or entirely, then the bores 200 can be filled with a sealant 100 or an epoxy in a filling step 60. For example, a first sealant 100 or epoxy may be used to penetrate the exposed portion 80. And a second sealant 100′ or epoxy may be used to fill the bores 200. The first and second sealant 100, 100′ can be blown into the bores 200 with a pressurized device, such as a pressurized paint machine, or pressurized washer, or manually, such as with a handheld caulking gun.

It should be understood, of course, that the foregoing relates to exemplary embodiments of the invention and that modifications may be made without departing from the spirit and scope of the invention as set forth in the following claims.

We claim:

1. A method of removing moisture from wood, comprising the steps of:
piercing the wood coring to create an exposed portion;
pumping fluid into the exposed portion;
penetrating the exposed portion with a sealant; and
filling the exposed portion with a sealant.

2. The method of claim 1, wherein said piercing step comprises the drilling of bores.

3. The method of claim 1, wherein said piercing step comprises the drilling of bores that are spaced apart by a distance of about 8 inches.

4. The method of claim 1, wherein the fluid is ultra dry air.

5. The method of claim 1, wherein the piercing step is performed to create a plurality of bores that interconnect within the coring.

6. The method of claim 1, the pumping step includes the use of a first machine to dry the air to create ultra dry air, and the use of a second machine that pumps the ultra dry air into the exposed portion.

7. The method of claim 1, wherein the piercing step comprises the forming of a plurality of bores throughout the stringer.

8. The method of claim 1, wherein the piercing step comprises the forming of a plurality of bores throughout the stringer, wherein the bore has an inlet end that is capable of receiving air, and an outlet end that is capable of allowing air to exit from the bores.

9. The method of claim 9, wherein an external air source is capable of being connected to said inlet end.

10. A method to remove moisture from wood coring of a boat, comprising:
creating holes into the wood coring;
pumping dry air into the holes; and
hermetically sealing the holes.

11. The method of claim 10, wherein said piercing step comprises the drilling of holes.

12. The method of claim 10, wherein said piercing step comprises the drilling of holes that are spaced apart by a distance of about 8 inches.

13. The method of claim 10, wherein the fluid is ultra dry air.

14. The method of claim 10, wherein the piercing step is performed to create a plurality of bores that interconnect within the coring.

15. The method of claim 10, the pumping step includes the use of a first machine to dry the air to create ultra dry air, and the use of a second machine that pumps the ultra dry air into the exposed portion.

16. The method of claim 10, wherein the piercing step comprises the forming of a plurality of bores throughout the stringer.

17. The method of claim 10, wherein the piercing step comprises the forming of a plurality of bores throughout the stringer, wherein the bore has an inlet end that is capable of receiving air, and an outlet end that is capable of allowing air to exit from the bores.

18. The method of claim 10, wherein an external air source is capable of being connected to said inlet end.

19. A method to remove moisture from wood coring of a boat, comprising:
creating holes into the wood coring;
sucking air from the holes; and
hermetically sealing the holes.
